(19) United States
(12) Patent Application Publication
(10) Pub. No.: US 2013/0084470 A1
(43) Pub. Date: Apr. 4, 2013

(54) MAGNETIC RECORDING MEDIUM

(71) Applicant: FUJIFILM CORPORATION, Tokyo (JP)

(72) Inventors: Yasushi HATTORI, Minami-ashigara-shi (JP); Ryota SUZUKI, Minami-ashigara-shi (JP); Norihito KASADA, Minami-ashigara-shi (JP)

(73) Assignee: FUJIFILM CORPORATION, Tokyo (JP)

(21) Appl. No.: 13/632,627

(22) Filed: Oct. 1, 2012

(30) Foreign Application Priority Data
Sep. 30, 2011 (JP) 2011-217783

(51) Int. Cl. G11B 5/706; G11B 5/702

(52) U.S. Cl. 428/842.3

(57) ABSTRACT

An aspect of the present invention relates to a magnetic recording medium comprising a magnetic layer containing a ferromagnetic powder and a binder on a nonmagnetic support, wherein the ferromagnetic powder has a hexagonal ferrite structure, the magnetic layer comprises a coefficient of friction-lowering component in the form of nonmagnetic inorganic particles, and a compound in which a substituent selected from the group consisting of a hydroxyl group and a carboxyl group is directly substituted on an aromatic ring.

### CROSS-REFERENCE TO RELATED APPLICATIONS

This application claims the benefit of priority under 35 USC 119 to Japanese Patent Application No. 2011-217783 filed on Sep. 30, 2011, which is expressly incorporated herein by reference in its entirety.

### BACKGROUND OF THE INVENTION

1. Field of the Invention

The present invention relates to a magnetic recording medium. More particularly, it relates to a magnetic recording medium affording good electromagnetic characteristics and good running durability.

2. Discussion of the Background

In recent years, as the quantity of recorded information has increased, ever higher recording densities have been demanded of magnetic recording media. Conventionally, primarily ferromagnetic metal magnetic powder has come to be employed in the magnetic layer of magnetic recording media. However, a limit has begun to appear in the improvement of ferromagnetic metal magnetic powder to achieve higher density recording. That is because as the particle size of a ferromagnetic metal powder decreases, thermal fluctuation ends up causing superparamagnetism, precluding use in magnetic recording media.

By contrast, hexagonal ferrite magnetic powder has high crystal magnetic anisotropy due to its crystalline structure and thus exhibits good thermal stability. Therefore, even with size reduction, it is possible to maintain good magnetic characteristics suited to magnetic recording. Further, magnetic recording media with magnetic layers in which hexagonal ferrite magnetic powder is employed can exhibit high-density characteristics based on the vertical component. Thus, hexagonal ferrite magnetic powder is a ferromagnetic magnetic material that is suited to achieving higher densities.

However, since hexagonal ferrite magnetic powder is tabular in form, in contrast to ferromagnetic metal magnetic powder, which is acicular in form, and since it has an easily magnetized axis in a direction perpendicular to the tabular surface thereof, it tends to undergo stacking (a state where the magnetic particles aggregate like the beads of an abacus). In order to achieve good electromagnetic characteristics in high-density recording, it is effective to enhance the dispersion of microparticulate magnetic material and improve surface smoothness of the magnetic layer. Thus, as a countermeasure, attempts have been made to prevent aggregation of ferromagnetic ferrite. In this context, reference can be made to Japanese Unexamined Patent Publication (KOKAI) Heisei No. 4-178916, Japanese Unexamined Patent Publication (KOKAI) Heisei No. 5-283218, Japanese Unexamined Patent Publication (KOKAI) Heisei No. 5-144615 or English language family members U.S. Pat. No. 5,378,547 and U.S. Pat. No. 5,494,749, Japanese Unexamined Patent Publication (KOKAI) No. 2002-298333 or English language family members US 2003/049490A1 and U.S. Pat. No. 6,689,455 B2, and Japanese Unexamined Patent Publication (KOKAI) No. 2009-099240 or English language family member US 2009/098414 A1, and Japanese Unexamined Patent Publication (KOKAI) No. 2002-373413, which are expressly incorporated herein by reference in their entirety.

As set forth above, it has been demanded for high-density recording-use magnetic recording media to enhance dispersion of the magnetic material. Accordingly, the present inventors conducted extensive research into discovering means of enhancing the dispersion of hexagonal ferrite magnetic powder that was suitable as high-density recording-use magnetic material. As a result, they determined that it was not necessarily easy to achieve both running durability, one of the characteristics demanded of magnetic recording media, and enhanced dispersion.

### SUMMARY OF THE INVENTION

An aspect of the present invention provides for a magnetic recording medium affording good running durability while enhancing the dispersion of hexagonal ferrite magnetic powder that is suitable as high-density recording-use magnetic material.

To enhance the dispersion of hexagonal ferrite magnetic powder in the magnetic layer of a particulate magnetic recording medium, it is effective to surround the hexagonal hexagonal particles with binder and inhibit the association (aggregation) of the hexagonal ferrite particles. To that end, it is important to increase the affinity of the surface of the hexagonal ferrite particles to the binder. In that regard, the present inventors conducted extensive research, resulting in the discovery of an additive component for modifying the surface of the hexagonal ferrite particles and increasing the affinity to the binder in the form of a compound (also referred to hereinafter as a “surface-modifying agent”) in which a substituent selected from the group consisting of a hydroxyl group and a carboxyl group is directly substituted on an aromatic ring. The binder that is employed in the magnetic layer is generally highly hydrophobic. In contrast, the surface of hexagonal ferrite particles is high hydrophilic. Accordingly, in that state, there is poor affinity between hexagonal ferrite particles and binder. However, the substituent of the above surface-modifying agent can adsorb to the surface of the hexagonal ferrite particle, thereby rendering the particle surface hydrophobic by means of the aromatic ring. Thus, the surface of the hexagonal ferrite particles is thought to be surrounded by binder, making it possible to inhibit diminished dispersion (aggregation) caused by the association of particles.

However, further research by the present inventors resulted in the new discovery that when the above surface-modifying agent was employed in combination with carbon black, which is widely employed as a magnetic layer component in particulate magnetic recording media, an adequate dispersion-enhancing effect could not be achieved. The present inventors presumed that since the surface-modifying agent tended to bond to the carbon black, the carbon black and the hexagonal ferrite particles associated through the surface-modifying agent, ultimately forming a coarse aggregate. However, since carbon black is a component that forms protrusions on the surface of the magnetic layer and lowers the coefficient of friction, simply leaving carbon black out as a component of the magnetic layer ended up decreasing running durability by increasing the coefficient of friction during running, despite achieving enhanced dispersion of the hexagonal ferrite magnetic powder (and thus increased surface smoothness).

Based on the above knowledge, the present inventors conducted still further extensive research resulting in the discovery that by employing nonmagnetic inorganic particles as a coefficient of friction-lowering component in a magnetic layer containing hexagonal ferrite magnetic powder and the above surface-modifying agent, it was possible to obtain a magnetic recording medium having good durability while enhancing the dispersion of the hexagonal ferrite magnetic powder. The present invention was devised on that basis.

An aspect of the present invention relates to a magnetic recording medium comprising a magnetic layer containing a ferromagnetic powder and a binder on a nonmagnetic support, wherein

the ferromagnetic powder has a hexagonal ferrite structure,

the magnetic layer comprises

a coefficient of friction-lowering component in the form of nonmagnetic inorganic particles, and

a compound in which a substituent selected from the group consisting of a hydroxyl group and a carboxyl group is directly substituted on an aromatic ring.

In one embodiment, the ferromagnetic powder is a hydrogen reduction product of a ferromagnetic hexagonal ferrite powder.

In one embodiment, the magnetic layer comprises no carbon black.

In one embodiment, the nonmagnetic inorganic particles are inorganic oxide colloid particles.

In one embodiment, the nonmagnetic inorganic particles are silica colloid particles.

In one embodiment, a number of aromatic ring contained in the compound is one.

In one embodiment, the aromatic ring is a naphthalene ring or a biphenyl ring.

In one embodiment, a number of the substituent contained in the aromatic ring is one or two.

In one embodiment, the compound is dihydroxynaphthalene or biphenylcarboxylic acid.

In one embodiment, the ferromagnetic powder has a ferrite composition denoted by general formula: AFe₁₂O₁₉, wherein A denotes at least one element selected from the group consisting of Ba, Sr, Pb, and Ca, and has a coercive force of equal to or lower than 2301 kA/m.

In one embodiment, an average particle size of the ferromagnetic powder is equal to or greater than 10 nm but equal to or lower than 30 nm.

In one embodiment, the magnetic layer comprises a granular substance that is different from the nonmagnetic inorganic particles.

The present invention can provide a magnetic recording medium affording both good surface smoothness and running durability.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

An aspect of the present invention relates to a magnetic recording medium comprising a magnetic layer containing a ferromagnetic powder and a binder on a nonmagnetic support.

The ferromagnetic powder has a hexagonal ferrite structure, as well as the magnetic layer comprises a coefficient of friction-lowering component in the form of nonmagnetic inorganic particles, and a compound (surface-modifying agent) in which a substituent selected from the group consisting of a hydroxyl group and a carboxyl group is directly substituted on an aromatic ring.

As set forth above, the magnetic recording medium of the present invention can achieve both good surface smoothness and running durability.

The magnetic recording medium of the present invention will be described in greater detail below.

### Surface-Modifying Agent

The magnetic recording medium of the present invention comprises a component (surface-modifying agent) in which a substituent selected from the group consisting of a hydroxyl group and a carboxyl group is directly substituted on an aromatic ring, in addition to the above ferromagnetic powder, binder, and nonmagnetic inorganic particles (coefficient of friction-lowering component). The mechanism of the surface-modifying agent is as set forth above.

The aromatic ring having a substituent that is present in the surface-modifying agent can be of a monocyclic structure or a polycyclic structure. It can be a carbon ring or a hetero ring. It can also be a polycyclic structure in the form of a condensed ring, or an assembly of rings in which two or more rings are linked through single bonds. Specific examples of the above aromatic ring are naphthalene rings, biphenyl rings, anthracene rings, pyrene rings, and phenanthrene rings. Examples of desirable aromatic rings are naphthalene rings, biphenyl rings, anthracene rings, and pyrene rings. Preferred examples of aromatic rings are naphthalene rings and biphenyl rings.

In the surface-modifying agent, a substituent selected from the group consisting of a hydroxyl group and a carboxyl group is directly substituted on the above-described aromatic ring. The presence of a substituent selected from the group consisting of a hydroxyl group and a carboxyl group can cause suitable adsorption to hexagonal ferrite magnetic particles and can inhibit aggregation. The number of substituents selected from the group consisting of a hydroxyl group and a carboxyl group that are contained in the compound need only be one, but two, three, or more may be present. To achieve suitable adsorptive strength, one or two are desirable.

The aromatic ring can contain other substituents in addition to the substituent selected from the group consisting of a hydroxyl group and a carboxyl group. Such substituents are not specifically limited. Examples are halogen atoms (such as fluorine atoms, chlorine atoms, bromine atoms, and iodine atoms) and alkyl groups. However, excessively strong adsorption of the surface-modifying agent to the magnetic particles is undesirable because it sometimes promotes the association of magnetic particles. From that perspective, the presence of substituents (such as sulfonic acid groups and their salts) exhibiting greater adsorption to the surface of magnetic particles than hydroxyl and carboxyl groups is undesirable. The presence of substituents greatly affecting the hydrophobic or hydrophilic property of the compound is also undesirable. From these perspectives, the surface-modifying agent desirably does not comprise substituents other than substituents selected from the group consisting of a hydroxyl group and a carboxyl group.

Further, the surface-modifying agent is desirably not a polymeric compound, such as the compounds employed as binders. That is because the more additive components that are employed in the magnetic layer, the lower the fill rate of the magnetic material becomes, which is undesirable from the perspective of high-density recording, and with a polymeric compound, a large quantity must be added to substantially enhance dispersion. It is desirable for the surface-modifying agent to comprise one aromatic ring within the molecule thereof to achieve a good dispersion-enhancing effect with the addition of a small quantity. In this context, a ring assembly in which two or more rings are linked by single bonds counts as a single aromatic ring. A compound in which two or more rings are linked through linking groups other than single bonds counts as having multiple aromatic rings. For the same reasons, the surface-modifying agent desirably has a molecular weight of equal to or lower than 1,000, preferably equal to or lower than 500, and more preferably, equal to or lower than 200. The lower limit of the molecular weight of the surface-modifying agent is not specifically limited. However, taking into account the molecular weight of the aromatic ring and substituent contained in the structure, the lower limit can be equal to or more than 100, or equal to or more than 150, for example.

The above-described surface-modifying agent is desirably a naphthalene directly substituted with the above substituent or a biphenyl directly substituted with the substituent; preferably a dihydroxynaphthalene or biphenylcarboxylic acid; and even more preferably, a dihydroxynaphthalene.

From the perspective of enhancing dispersion, in the magnetic recording medium of the present invention, the surface-modifying agent is desirably contained in a magnetic layer in a quantity of equal to or more than 1.5 weight parts per 100 weight parts of the ferromagnetic powder. As stated above, from the perspective of high-density recording, a high fill rate of ferromagnetic powder is desirable, and the quantity of additive that is added is desirably kept low within the range within which it is effective. From this perspective, the content of the surface-modifying agent in the magnetic layer is desirably kept to equal to or less than 10 weight parts per 100 weight parts of ferromagnetic powder. From the perspective of achieving both dispersion and fill rate of the ferromagnetic powder, the content of the surface-modifying agent in the magnetic layer is preferably 3 to 10 weight parts per 100 weight parts of ferromagnetic powder.

### Ferromagnetic Powder

In the present invention, the ferromagnetic powder the dispersion of which can be enhanced by the surface-modifying agent has a hexagonal ferrite structure. Due to the hexagonal ferrite structure, the ferromagnetic powder has high crystal magnetic anisotropy and good thermal stability, so that good magnetic characteristics suited to magnetic recording can be maintained even when the powder is extremely fine. The magnetic recording medium with the magnetic layer in which the above ferromagnetic powder is employed can exhibit good high-density characteristics based on the vertical component thereof.

An example of one form of the ferromagnetic powder is hexagonal ferrite magnetic powder manufactured by a known method such as the glass crystallization method, hydrothermal synthesis method, or coprecipitation method, and hexagonal ferrite magnetic powder obtained by subjecting such a powder to a slow oxidation treatment by any known method. The hexagonal ferrite can be, for example, barium ferrite, strontium ferrite, lead ferrite, calcium ferrite, and various substitution products thereof, such as Co substitution products. Specific examples are magnetoplumbite-type barium ferrite and strontium ferrite, magnetoplumbite-type ferrites with particle surfaces covered with spinel, and magnetoplumbite-type barium ferrite and strontium ferrite with partial spinel phases. Additionally, in addition to the prescribed atoms, atoms such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, and Nb can be contained. Generally, ferromagnetic powder to which elements such as Co—Zn, Co—Ti, Co—Ti—Zr, Co—Ti—Zn, Ni—Ti—Zn, Nb—Zn—Co, Sb—Zn—Co, and Nb—Zn have been added can generally be employed.

When the magnetic particles are small in size, the energy (magnetic anisotropy energy) aligning the magnetic particles in the direction of magnetization fails to overcome thermal energy, and so-called thermal fluctuation causes recording retention to decrease. By contrast, in a hexagonal ferrite magnetic powder, there is high crystal magnetic anisotropy as a result of the crystalline structure, so that the decrease in magnetic characteristics due to thermal fluctuation is small even when fine particles are employed to achieve higher density recording. However, the high crystal magnetic anisotropy also results in high coercive force, necessitating a large external magnetic field for recording and compromising recording properties. Accordingly, to achieve both thermal stability and ease of recording, it is desirable to lower the coercive force while retaining the crystalline structure of hexagonal ferrite.

In this regard, the present inventors discovered that it was possible to lower the coercive force (and thus enhance recording properties) by hydrogen reduction of the hexagonal ferrite magnetic particles. That is, a desirable form of the ferromagnetic powder employed in the present invention is the hydrogen reduction product of the ferromagnetic hexagonal ferrite powder. Generally, the coercive force of hexagonal ferrite magnetic powder with good thermal stability will be equal to or higher than 230 kA/m, even equal to or higher than 235 kA/m. The coercive force of the hexagonal ferrite magnetic powder that is generally available is normally about equal to or lower than 500 kA/m. By contrast, it is desirable for the above hydrogen reduction product to have a coercive force of less than 235 kA/m, or less than 230 kA/m, from the perspective of ease of recording. The coercive force of the ferromagnetic powder employed in the magnetic layer in the present invention is desirably equal to or higher than 120 kA/m, preferably equal to or higher than 160 kA/m. That is because when the coercive force is excessively low, the effects of adjacent recorded bits make it difficult to retain the recording, and thermal stability diminishes.

To lower the coercive force of hexagonal ferrite, substitution elements are sometimes substituted for Fe as coercive force-adjusting components. However, the introduction of substitution elements may diminish crystal magnetic anisotropy, which is undesirable from the perspective of thermal stability. Accordingly, in the present invention, it is desirable to employ either a hexagonal ferrite magnetic powder that does not contain substitution elements, or the hydrogen reduction product of such a powder, as the ferromagnetic powder. A “hexagonal ferrite magnetic powder that does not contain substitution elements” is one having the composition denoted by the general formula AFe₁₂O₁₉ (where A denotes at least one element selected from the group consisting of Ba, Sr, Pb, and Ca).

The hydrogen reduction will be described in detail below.

Hydrogen reduction is conducted by heat treating hexagonal ferrite magnetic powder in a reducing gas in the form of a hydrogen-containing atmosphere. Although hydrocarbons and carbon monoxide are also known as reducing gases, when hydrocarbons and carbon monoxide are employed, carbon components sometimes deposit on the surface of the magnetic particles in the form of by-products. As set forth above, the surface-modifying agent tends to bond to carbon black (that is, carbon components), so it is presumed that the deposition of carbon components would cause the surface-modifying agent to tend to adsorb to the surface of the magnetic particles. In this regard, Japanese Unexamined Patent Publication (KOKAI) Heisei No. 7-57242 states that the presence of carbon components on the surface of the magnetic particles is desirable for retaining a prescribed aromatic compound on the surface of the magnetic layer. However, this adsorption is not because of the above substituent (hydroxyl group, carboxyl group), but is thought to be due to bonding of the carbon component and the aromatic ring. Thus, it becomes difficult to achieve the desirable effect of the surface-modifying agent, namely, covering the surface of the magnetic particles with aromatic rings and rendering the surface of the magnetic particles hydrophobic (and thereby enhancing affinity to the binder) to enhance dispersion of the magnetic particles. For this reason, carbon components (carbon, CO, CO₂) are desirably not present on the surface of the ferromagnetic powder employed in the present invention. Accordingly, the hydrogen reduction is desirably conducted in an atmosphere containing just hydrogen as reducing gas. From the perspective of reaction efficiency, the content of the hydrogen in the reducing atmosphere is desirably equal to or greater than 50 volume %, preferably equal to or greater than 90 volume %. Providing a gas inlet and a gas outlet in the reactor and constantly discharging the gas following the reaction while introducing a reducing gas flow during reduction decomposition are preferred from the perspective of reaction efficiency. Reduction decomposition in a reducing gas flow is advantageous in that by-products of the reduction reaction are carried off by the gas phase without contamination by impurities in the form of Ca such as occurs in Ca reduction. To eliminate the by-products of reduction processing, the discharged gas can be processed with scrubbers. Out of concern for safety, hydrogen diluted with an inert gas is desirably employed. However, when using equipment under conditions where safety can be ensured, the use of a 100% hydrogen atmosphere (that is, pure hydrogen) is naturally possible, and even desirable from the perspective of reaction efficiency.

Improving recording properties by lowering the coercive force by means of hydrogen reduction is desirable. However, to maintain the thermal stability due to the crystalline structure of hexagonal ferrite, it is desirable to maintain the crystalline structure of the hexagonal ferrite even following reduction processing. Accordingly, the reaction conditions of the hydrogen reduction are desirably set to relatively mild conditions so that the crystalline structure of the hexagonal ferrite is not damaged by the reduction processing. Retention of the crystalline structure of the hexagonal ferrite following reduction processing can be confirmed by detecting the peak derived from hexagonal ferrite in X-ray diffraction analysis of the hydrogen reduction product.

Specifically, the heat processing temperature in hydrogen reduction desirably falls within a range of 100 to 200° C. as an internal reaction furnace temperature. The heat processing temperature is preferably equal to or lower than 195° C. in terms of process management. From the perspective of shortening the processing time, it is preferably equal to or higher than 130° C., more preferably equal to or higher than 160° C. The reduction processing time is not specifically limited other than that it be set to achieve a magnetic powder of the desired coercive force based on the hydrogen concentration of the reducing atmosphere and the like. From the perspective of productivity and the like, it is desirably about 5 to 30 minutes. For example, when employing pure hydrogen, about 5 to 25 minutes is suitable.

The reduction processing can be conducted with the hexagonal ferrite magnetic powder in a reactor with an opening in the top thereof disposed within a reaction chamber. In that case, it is desirable to suitably stir the particles in the container so that the hexagonal ferrite magnetic powder that is positioned at the bottom of the reactor comes into contact with the reducing atmosphere. To that end, a rotary kiln and the like is desirably employed. To further enhance handling properties, it is desirable for the magnetic powder to be subjected to an oxidation treatment following the reduction treatment to form an oxide layer on the outermost surface thereof. The oxidation treatment can be conducted by a known slow oxidation treatment.

Regardless of whether the above reduction processing is conducted, from the perspective of high-density recording, the average particle size of the ferromagnetic powder contained in the magnetic layer of the magnetic recording medium of the present invention is desirably equal to or lower than 30 nm, preferably equal to or lower than 25 nm. To achieve stable magnetization, the average particle size is desirably equal to or greater than 10 nm. There is essentially no change in particle size due to hydrogen reduction. Thus, the average particle size of the hydrogen reduction product will be the same as that of the starting material hexagonal ferrite magnetic powder prior to reduction processing.

The average particle size in the present invention is a value measured by the following method, unless specifically stated otherwise.

Particles of hexagonal ferrite powder or the like are photographed at a magnification of 100,000-fold with a model H-9000 transmission electron microscope made by Hitachi and printed on photographic paper at a total magnification of 500,000-fold to obtain particle photographs. The targeted particle is selected from the particle photographs, the contours of the particle are traced with a digitizer, and the size of the particle is measured with KS-400 image analyzer software from Carl Zeiss. The size of 500 particles is measured. The average value of the particle size measured by the above method is adopted as an average particle size.

The size of various powders in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method.

The average powder size of the powder is the arithmetic average of the above powder size and is calculated by measuring five hundred primary particles in the above-described method. The term “primary particle” refers to a nonaggregated, independent particle.

The average acicular ratio of the powder refers to the arithmetic average of the value of the (major axis length/minor axis length) of each powder, obtained by measuring the length of the minor axis of the powder in the above measurement, that is, the minor axis length. The term “minor axis length” means the length of the minor axis constituting a powder for a powder size of definition (1) above, and refers to the thickness or height for definition (2) above. For (3) above, the (major axis length/minor axis length) can be deemed for the sake of convenience to be 1, since there is no difference between the major and minor axes.

When the shape of the powder is specified, for example, as in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter).

### Coefficient of Friction-Lowering Component

The magnetic recording medium of the present invention comprises nonmagnetic inorganic particles as a coefficient of friction-lowering component along with the above surface-modifying agent and ferromagnetic powder. In the present invention, the term “coefficient of friction-lowering component” means a component that, by forming suitable protrusions on the surface of the magnetic layer, exhibits the effect of lowering the coefficient of friction that is produced in the course of contact between the magnetic recording medium and the head during the recording or reproduction of a magnetic signal, relative to when this component is not incorporated. Carbon black has conventionally been widely employed as a coefficient of friction-lowering component in magnetic recording media. However, as set forth above, the surface-modifying agent may not adequately enhance dispersion of the ferromagnetic powder in the presence of carbon black. Thus, nonmagnetic inorganic particles are employed as the coefficient of friction-lowering component in the present invention. The nonmagnetic inorganic particles in the present invention do not include carbon black. The fact that the magnetic layer of the magnetic recording medium of the present invention does not contain carbon black is desirable for the surface-modifying agent to produce a good dispersion-enhancing effect. In this context, the phrase “does not contain carbon black” or “comprises no carbon black” means that no carbon black is actively added as a magnetic layer component. For example, it is permissible for carbon black contained as a component of other layers (such as carbon black in the nonmagnetic layer) to be unintentionally incorporated into the magnetic layer in the process of manufacturing a magnetic recording medium.

Examples of the inorganic substance constituting the nonmagnetic inorganic particles are metal oxides, metal carbonates, metal sulfates, metal nitrides, metal carbides, and metal sulfides. Specific examples are α-alumina with an α-conversion rate of equal to or higher than 90%, β-alumina, γ-alumina, θ-alumina, silicon dioxide, silicon carbide, chromium oxide, cerium oxide, α-iron oxide, goethite, corundum, silicon nitride, titanium carbide, titanium dioxide, tin oxide, magnesium oxide, tungsten oxide, zirconium oxide, boron nitride, zinc oxide, calcium carbonate, calcium sulfate, barium sulfate, and molybdenum disulfide, which can be employed singly or in combinations of two or more. From the perspective of readily obtaining particles of good size distribution and dispersion, inorganic oxides are desirable and silica (silicon dioxide) is preferred.

From the perspective of dispersibility, colloidal particles are desirably employed as the nonmagnetic inorganic particles. From the perspective of availability, inorganic colloidal particles are desirable and inorganic oxide colloidal particles are preferred. Colloidal particles of the above-listed inorganic oxides are examples of the inorganic oxide colloidal particles. Specific examples include complex inorganic oxide colloidal particles in the form of SiO₂.Al₂O₃, SiO₂.B₂O₃, TiO₂.CeO₂, SnO₂.Sb₂O₃, SiO₂.Al₂O₃.TiO₂, and TiO₂.CeO₂:SiO₂. Desirable examples are inorganic oxide colloidal particles such as SiO₂, Al₂O₃, TiO₂, ZrO₂, and Fe₂O₃. From the perspective of the availability of monodisperse colloidal particles, silica colloidal particles (colloidal silica) is preferred.

Since colloidal particles generally have hydrophilic surfaces, they are suited to the preparation of colloidal liquids employing water as the dispersion medium. For example, colloidal silica obtained by the usual synthesis methods has a surface that is covered with polarized oxygen atoms (O²⁻), and will thus adsorb to water when in water, forming hydroxyl groups and stabilizing. However, these particles tend not to remain in the form of a colloid when placed in an organic solvent employed in the coating liquid of a magnetic tape. Accordingly, the surface of the particles is treated to render it hydrophobic to permit dispersion of these particles in the form of a colloid in organic solvents. Such colloidal particles that have been treated to render them hydrophobic are desirably employed in the present invention, as well. The details of such hydrophobic treatments are given in, for example, Japanese Unexamined Patent Publication (KOKAI) Heisei Nos. 5-269365 and 5-287213, and Japanese Unexamined Patent Publication (KOKAI) No. 2007-63117, which are expressly incorporated herein by reference in their entirety. Colloidal particles that have been subjected to such a surface treatment can be synthesized by the methods described in the above-cited publications and the like, or procured as commercial products.

From the perspective of forming suitable protrusions that contribute to lowering the coefficient of friction on the surface of the magnetic layer, the average particle size of the nonmagnetic inorganic particles is desirably equal to or greater than—preferably equal to or more than 1.2-fold—the thickness of the magnetic layer. From the perspective of preventing spacing loss due to excess protrusions of nonmagnetic inorganic particles, an average particle size that is equal to or less than two-fold, preferably equal to or less than 1.7-fold, the thickness of the magnetic layer is desirable. To achieve even better electromagnetic characteristics, the average particle size of the nonmagnetic inorganic particles desirably falls within a range of 50 to 200 nm. From the perspective of further enhancing electromagnetic characteristics, the thickness of the magnetic layer is desirably equal to or less than 200 nm, preferably equal to or less than 170 nm. From the perspective of forming a uniform magnetic layer, it is desirably equal to or more than 30 nm, preferably equal to or more than 50 nm.

The average particle size of the nonmagnetic inorganic particle is a value measured by the following method.

Photographs of the particles of a nonmagnetic inorganic particle are printed on photographic paper with a transmission electron microscope. For example, a model H-9000 transmission electron microscope made by Hitachi can be used to photograph particles at a magnification of about 50,000-fold to about 10,000-fold and print the photograph on photographic paper to obtain a particle photograph.

Next, 50 particles are randomly extracted from the particle photograph, the contour of each particle is traced with a digitizer, and the diameter of a circle of identical area (the diameter corresponding to a circular area) to the traced region is calculated. In the present invention, the term “particle size of the nonmagnetic inorganic particle” refers to the diameter thus calculated. The image analysis software KS-400 made by Carl Zeiss can be employed to calculate particle sizes, for example. Further, a circle with a diameter of 1 cm, for example, can be used in scale correction in the course of incorporating images from the scanner and analyzing them.

The arithmetic average of the diameters of the 50 particles measured by the above method is adopted as the average particle size of the nonmagnetic inorganic particle. The same holds true for the average particle size of the granular substance contained in the magnetic layer, described further below.

The average particle size that is obtained by the above method is an average value that is calculated from 50 primary particles. The term “primary particle” means an independent, non-aggregated particle. Accordingly, the sample particles that are used to measure the average particle size of the nonmagnetic inorganic particle can be sample powder collected from the magnetic layer or starting material powder so long as the size of the primary particles can be measured. Sample powder can be collected from the magnetic layer, for example, by the method descried in paragraph [0015] of Japanese Unexamined Patent Publication (KOKAI) No. 2011-48878, which is expressly incorporated herein by reference in its entirety.

The content of nonmagnetic inorganic particles in the magnetic layer is desirably set to within a range allowing the achievement of both good electromagnetic characteristics and a reduction in the coefficient of friction. Specifically, 0.5 to 5 weight parts are desirable, and 1 to 3 weight parts are preferable, per 100 weight parts of ferromagnetic powder.

### Additives

Additives can be added as needed to the magnetic layer as well as to the nonmagnetic layer described further below. Examples of additives are abrasives, lubricants, dispersing agents, dispersion adjuvants, antifungal agents, antistatic agents, oxidation inhibitors, and solvents. For details such as specific examples of these additives, reference can be made to paragraphs [0075] to [0083] of Japanese Unexamined Patent Publication (KOKAI) No. 2006-108282, which is expressly incorporated herein by reference in its entirety, for example. Different types and quantities of additives can be employed in the present invention in the magnetic layer and nonmagnetic layer, described further below. All or some part of the additives employed in the present invention can be added during any of the steps in the course of manufacturing the coating liquid for the magnetic layer or nonmagnetic layer. For example, there are cases in which they are admixed to the ferromagnetic powder prior to the kneading step; cases in which they are added in the step of kneading the ferromagnetic powder, binder, and solvent; cases in which they are added in the dispersing step; cases in which they are added following dispersion; and cases in which they are added immediately prior to coating.

In the present invention, the magnetic layer additives desirably contain granular substances comprised of different materials than the nonmagnetic inorganic particles. Inorganic powders that are added as abrasives can generally be employed as such granular substances. In the present invention, the abrasives that are contained in the magnetic layer are granular substances with a higher Mohs' hardness than the nonmagnetic inorganic particles contained as coefficient of friction-lowering components in the same layer. For example, the Mohs' hardness of silica particles is 7. Thus, in a magnetic layer containing silica particles as nonmagnetic inorganic particles, a granular substance having a Mohs' hardness of equal to or greater than 8 would correspond to an abrasive. Incorporating an abrasive into the magnetic layer makes it possible to increase the abrasiveness of the magnetic layer and remove material adhering to the head. From the perspective of increasing the abrasiveness of the magnetic layer, the use of an abrasive in the form of an inorganic powder with a Mohs' hardness equal to or higher than 8 is desirable, and the use of an inorganic powder with a Mohs' hardness of equal to or higher than 9 is preferred. The maximum value of the Mohs' hardness scale is the value of diamond, 10. Specific examples are alumina (Al₂O₃), silicon carbide, boron carbide (B₄C), TiC, cerium oxide, zirconium oxide (ZrO₂), and diamond powder. Of these, alumina, silicon carbide, and diamond are desirable. These inorganic powders can be of any shape, such as acicular, spherical, and cubic. Those having a shape with an angular portion afford great abrasiveness and are thus desirable. Inorganic powders employed as abrasives in this manner could conceivably form protrusions on the surface of the magnetic layer and lower the coefficient of friction. However, when magnetic layer surface protrusions of a quantity capable of maintaining running durability are formed by just abrasive protrusions, the friction capacity becomes excessively high and head damage becomes pronounced. Additionally, it becomes difficult to lower the coefficient of friction when protrusions are formed of abrasive in a range that does not greatly damage the head. Accordingly, in the present invention, the combined use of nonmagnetic inorganic particles and abrasives is desirable. From the perspective of avoiding major head damage by abrasives, the average particle diameter of the abrasive is desirably 10 to 300 nm, preferably 30 to 250 nm, and more preferably, 50 to 200 nm. The quantity added is desirably 1 to 20 weight parts, preferably 2 to 15 weight parts, and more preferably 3 to 10 weight parts per 100 weight parts of ferromagnetic powder.

### Binder

In the present invention, conventionally known thermoplastic resins, thermosetting resins, reactive resins, and mixtures thereof are examples of the binders employed in the magnetic layer and nonmagnetic layer described further below. For details, reference can be made to paragraphs [0044] to [0054] in Japanese Unexamined Patent Publication (KOKAI) No. 2006-108282, which is expressly incorporated herein by reference in its entirety, for example. The quantity of binder added is desirably 5 to 30 weight parts per 100 weight parts of ferromagnetic powder in the magnetic layer, and desirably 10 to 20 weight parts per 100 weight parts of nonmagnetic powder in the nonmagnetic layer. In addition to binder, curing agents such as polyisocyanate compounds can be employed. For details, reference can be made to paragraphs and [0056] in Japanese Unexamined Patent Publication (KOKAI) No. 2006-108282, which is expressly incorporated herein by reference in its entirety. The quantities employed can be suitably set.

### Nonmagnetic Layer

The magnetic recording medium of the present invention can comprise a nonmagnetic layer comprising a nonmagnetic powder and binder between the nonmagnetic support and the magnetic layer. So long as the nonmagnetic layer is essentially nonmagnetic, it will produce its effect. For example, it can contain impurities in the form of unintentionally incorporated small quantities of magnetic powder (magnetic materials). The term “essentially nonmagnetic” means a residual magnetic flux density of equal to or less than 0.01 T or a coercive force of equal to or less than 7.96 kA/m (100 Oe), desirably no residual magnetic flux density or coercive force at all. The thickness of the nonmagnetic layer can be, for example, 0.2 μm to 5.0 μm, is desirably 0.3 μm to 3.0 μm, and is preferably 1.0 μm to 2.5 μm. For additional details relating to the nonmagnetic layer, reference can be made to paragraphs [0086] to [0101] of Japanese Unexamined Patent Publication (KOKAI) No. 2006-108282, which is expressly incorporated herein by reference in its entirety. In the magnetic recording medium of the present invention, it is better to exclude carbon black as a magnetic layer component so that the surface-modifying agent will adequately enhance dispersion of the ferromagnetic powder. However, carbon black can be added to the nonmagnetic layer to lower surface resistivity or the like.

The nonmagnetic layer and magnetic layer can be formed by simultaneous multilayer coating (wet-on-wet) by applying the magnetic layer coating liquid while the nonmagnetic layer coating liquid is still wet, or by sequential multilayer coating (wet-on-dry) by applying the magnetic layer coating liquid after the nonmagnetic layer coating liquid has dried. To form a suitable quantity of protrusions for effectively lowering the coefficient of friction on the surface of the magnetic layer, it is desirable for the quantity of nonmagnetic inorganic particles seeping into the magnetic layer and the quantity of abrasive component seeping into the nonmagnetic layer to be small. From this perspective, sequential multilayer coating is desirable. For details regarding methods of manufacturing magnetic recording media, reference can be made to paragraphs [0057] to [0067] of Japanese Unexamined Patent Publication (KOKAI) No. 2006-108282, which is expressly incorporated herein by reference in its entirety.

### Layer Structure

In the magnetic recording medium of the present invention, the nonmagnetic support is desirably 3 to 10 μm in thickness. A known backcoat layer can be formed on the opposite surface of the nonmagnetic support from the surface on which the magnetic layer is formed. The backcoat layer is, for example, 0.1 to 1.0 μm, desirably 0.2 to 0.8 μm, in thickness. The thickness of the magnetic layer and the thickness of the nonmagnetic layer in the magnetic recording medium of the present invention are as set forth above.

With regard to additional details on the magnetic recording medium of the present invention, known techniques for magnetic recording media can be applied.

### EXAMPLES

The present invention will be described in detail below based on Examples. However, the present invention is not limited to the examples. The “parts” given in Examples is weight parts.

### Preparation Example 1

The following method was used to prepare a hydrogen reduction product of barium ferrite magnetic powder.

The barium ferrite (referred to as “BaFe” hereinafter; ferrite composition: BaFe₁₂O₁₉) described in Table 1 below was heat treated (reduction processed) while constantly causing a pure hydrogen gas flow (1 L/min) to enter from the gas inlet and discharging the gas following the reaction from the discharge outlet of a reaction furnace. The reaction furnace employed was a Gold Image Furnace (P810C) made by ULVAC-RIKO. The temperature was raised at a rate of 150° C./min to 190° C. A heat treatment was conducted for 15 min at that temperature. Subsequently, the interior of the furnace was cooled at a rate of 20° C./min to 30° C., at which point air was introduced. Subsequently, the temperature was raised by several degrees, and then cooled to room temperature.

The hydrogen reduction product thus obtained was subjected to X-ray diffraction analysis in an X-ray diffraction apparatus, and a pattern exhibiting hexagonal ferrite that was identical to that of the BaFe prior to processing was confirmed. Based on these results, the magnetic powder obtained by reduction processing was confirmed to have retained a crystalline structure of hexagonal ferrite identical to that prior to reduction processing.

TABLE 1

| | Average plate | Average plate | Average particle |
|---|---|---|---|
| S_{BET} (m²/g) | diameter (nm) | thickness (nm) | volume (nm³) |
| 79.5 | 20.6 | 6.1 | 1,681 |

Evaluation Methods

(1) Specific Surface Area S_{BET}

Measurement of the S_{BET} given in Table 1 was conducted by the nitrogen adsorption method.

(2) Particle Size Evaluation (Average Plate Diameter, Average Plate Thickness, Average Particle Volume by TEM Observation)

The particles sizes given in Table 1 were measured with a transmission electron microscope (applied voltage 200 kV) made by Hitachi.

(3) Magnetic Characteristics

The coercive forces of the magnetic powder before and after the hydrogen reduction processing were evaluated under conditions of an applied magnetic field of 3,184 kA/m (40 kOe) with a superconducting vibrating sample magnetometer (VSM) made by Tamagawa Co. Results are shown in Table 2.

TABLE 2

| Magnetic powder | Hc |
|---|---|
| BaFe | 3180 Oe |
| | (253 kA/m) |
| Hydrogen reduction product of BaFe | 2600 Oe |
| | (207 kA/m) |

### Example 1

### 1.1 Formula of Magnetic Layer Coating Liquid

Barium ferrite magnetic powder described in Table 1: 100 parts
Polyurethane resin (functional group: —SO₃Na, functional group concentration: 180 eq/t): 14 parts
Oleic acid: 1.5 parts
2,3-Dihydroxynaphthalene: 6 parts
Alumina powder (average particle diameter: 120 nm): 6 parts
Silica colloid particles (colloidal silica: average particle size: 100 nm): 2 parts
Cyclohexanone: 110 parts
Methyl ethyl ketone: 100 parts
Toluene: 100 parts
Butyl stearate: 2 parts
Stearic acid: 1 part

### 1-2. Formula of Nonmagnetic Layer Coating Liquid

Nonmagnetic inorganic powder (α-iron oxide): 85 parts
Surface treatment agents: Al₂O₃, SiO₂
Major axis diameter: 0.05 μm
Tap density: 0.8
Acicular ratio: 7
Specific surface area by BET method: 52 m²/g
pH: 8
DBP oil absorption capacity: 33 g/100 g

Carbon black: 20 parts
DBP oil absorption capacity: 120 mL/100 g
pH: 8
Specific surface area by BET method: 250 m²/g
Volatile component: 1.5%

Polyurethane resin (functional group: —SO₃Na, functional
group concentration: 180 eq/t): 15 parts

Phenyl phosphonic acid: 3 parts

α-Al₂O₃ (average particle diameter 0.2 um): 10 parts

Cyclohexanone: 140 parts

Methyl ethyl ketone: 170 parts

Butyl stearate: 2 parts

Stearic acid: 1 part

### 1-3. Preparation of Magnetic Tape

The various components of each of the above coating liquids were kneaded for 60 minutes in an open kneader, and then dispersed for 720 to 1,080 minutes in a sandmill employing zirconia beads (particle diameter 0.5 mm or 0.1 mm). To each of the dispersions obtained were added 6 parts of a trifunctional low-molecular-weight polyisocyanate compound (Coronate 3041 made by Nippon Polyurethane Industry Co., Ltd.). The mixtures were stirred for another 20 minutes and passed through filters having a mean pore diameter of 1 μm to prepare a magnetic layer coating liquid and a nonmagnetic layer coating liquid.

The nonmagnetic layer coating liquid was coated in a quantity calculated to yield a thickness upon drying of 1.5 μm on a polyethylene naphthalate base 5 μm in thickness and dried at 100° C. Immediately thereafter, the magnetic layer coating liquid was coated to a thickness yielding 0.08 μm upon drying in a wet-on-dry coating, and dried at 100° C. At the time, while the magnetic layer was still wet, vertical magnetic field orientation was conducted with a 300 mT (3,000 gauss) magnet. The product was then subjected to surface smoothing at a temperature of 90° C., a linear pressure of 300 kg/cm, and a rate of 100 in/min in a seven-stage calender comprised of just metal rolls; subjected to a thermosetting treatment for 24 hours at 70° C.; and slit to ½ inch width to prepare a magnetic tape.

### Example 2

With the exception that 100 parts of the BaFe hydrogen reduction product obtained in Preparation Example 1 were employed as the ferromagnetic powder, a magnetic tape was prepared by the same method as in Example 1.

### Example 3

With the exception that the 6 parts of 2,3-dihydroxynaphthalene in the magnetic layer components were changed to 6 parts of biphenylcarboxylic acid, a magnetic tape was prepared by the same method as in Example 1.

### Comparative Example 1

With the exception that the colloidal silica was omitted from the magnetic layer components, a magnetic tape was prepared by the same method as in Example 1.

### Comparative Example 2

With the exception that 20 parts of carbon black with an average particle size of 15 nm were used instead of the 20 parts of colloidal silica as a magnetic layer component, a magnetic tape was prepared by the same method as in Example 1.

### Comparative Example 3

With the exception that the 2,3-dihydroxynaphthalene was omitted from the magnetic layer components, a magnetic tape was prepared by the same method as in Comparative Example 2.

### Comparative Example 4

With the exception that the 2,3-dihydroxynaphthalene was omitted from the magnetic layer components, a magnetic tape was prepared by the same method as in Example 1.

### Comparative Example 5

With the exception that colloidal silica was omitted from the magnetic layer components, a magnetic tape was prepared by the same method as in Example 2.

### Comparative Example 6

With the exception that the 20 parts of colloidal silica were replaced with 20 parts of carbon black with an average particle size of 15 nm in the magnetic layer components, a magnetic tape was prepared by the same method as in Example 2.

### Comparative Example 7

With the exception that the 2,3-dihydroxynaphthalene was omitted from the magnetic layer components, a magnetic tape was prepared by the same method as in Comparative Example 6.

### Comparative Example 8

With the exception that the 2,3-dihydroxynaphthalene was omitted from the magnetic layer components, a magnetic tape was prepared by the same method as in Example 2.

Methods of Evaluating Magnetic Tape

(1) Magnetic Characteristics

The coercive force Hc of the magnetic tape was evaluated under conditions of applying a magnetic field of 3,184 kA/m (40 kOe) using a superconducting vibrating sample magnetometer (VSM) made by Tamagawa Co. The results are given in Table 3.

(2) Surface Roughness Ra of Magnetic Layer

An area of 40 μm×40 μm of the magnetic layer surface was measured in contact mode by an atomic force microscope (AFM: Nanoscope III made by Digital Instruments) to determine the centerline average surface roughness (Ra). The results are given in Table 3.

(3) Measurement of Coefficient of Friction

The magnetic layer surface of the magnetic tape was subjected to a 100 g load with a cylindrical SUS rod with a centerline average surface roughness Ra of 5 nm as measured by AFM, the rod was slid back and forth 100 times at a rate of 10 mm/s, and the coefficient of friction (μ value) was determined. The results are given in Table 3. In Table 3, a notation of “Adhered” means that the coefficient of friction was excessively high and the cylindrical SUS rod adhered to the surface of the magnetic layer, precluding back and forth sliding.

TABLE 3

| | | | Coefficient of | | | |
|---|---|---|---|---|---|---|
| | Ferromagnetic | Surface-modifying | friction-lowering | Coercive force | | |
| | Powder | agent | component | Hc of tape | Ra (nm) | μ value |
| Ex. 1 | BaFe | 2,3-Dihydroxynaphthalene | Colloidal silica | 3700 Oe | 1.8 | 0.23 |
| | | | | (295 kA/m) | | |
| Ex. 2 | Hydrogen reduction | 2,3-dihydroxynaphthalene | Colloidal silica | 2800 Oe | 1.8 | 0.22 |
| | product of BaFe | | | (223 kA/m) | | |
| Ex. 3 | BaFe | Biphenylcarboxylic acid | Colloidal silica | 3650 Oe | 1.9 | 0.22 |
| | | | | (291 kA/m) | | |
| Comp. | BaFe | 2,3-Dihydroxynaphthalene | — | 3790 Oe | 1.8 | Adhered |
| Ex. 1 | | | | (302 kA/m) | | |
| Comp. | BaFe | 2,3-Dihydroxynaphthalene | Carbon black | 3680 Oe | 2.8 | 0.19 |
| Ex. 2 | | | | (293 kA/m) | | |
| Comp. | BaFe | — | Carbon black | 3730 Oe | 2.9 | 0.2 |
| Ex. 3 | | | | (297 kA/m) | | |
| Comp. | BaFe | — | Colloidal silica | 3720 Oe | 3 | 0.19 |
| Ex. 4 | | | | (296 kA/m) | | |
| Comp. | Hydrogen reduction | 2,3-Dihydroxynaphthalene | — | 2770 Oe | 1.9 | Adhered |
| Ex. 5 | product of BaFe | | | (220 kA/m) | | |
| Comp. | Hydrogen reduction | 2,3-Dihydroxynaphthalene | Carbon black | 2810 Oe | 2.8 | 0.2 |
| Ex. 6 | product of BaFe | | | (224 kA/m) | | |
| Comp. | Hydrogen reduction | — | Carbon black | 2780 Oe | 2.8 | 0.19 |
| Ex. 7 | product of BaFe | | | (221 kA/m) | | |
| Comp. | Hydrogen reduction | — | Colloidal silica | 2790 Oe | 2.9 | 0.19 |
| Ex. 8 | product of BaFe | | | (222 kA/m) | | |

Evaluation of Results

From the perspective of inhibiting a drop in electromagnetic characteristics due to spacing fluctuation, it is desirable to lower the surface roughness of the magnetic layer surface within the range where running durability can be maintained. On that basis, the magnetic layer surface roughness, as a surface roughness Ra measured by the method set forth above, desirably ranges from 1.0 to 2.0 nm. As indicated in Table 3, Examples 1 to 3 exhibited higher magnetic layer surface smoothness than Comparative Examples 3, 4, 7, and 8, which employed identical ferromagnetic powder but did not contain either 2,3-dihydroxynaphthalene or biphenylcarboxylic acid. The fact that the above desirable surface roughness Ra was exhibited indicated that the surface-modifying agent had a good dispersion-enhancing effect. However, Comparative Examples 2 and 6, which contained 2,3-dihydroxynaphthalene and carbon black as magnetic layer components, exhibited a substantial drop in magnetic layer surface smoothness relative to Examples 1 to 3, which contained the same ferromagnetic powder but also contained colloidal silica as a coefficient of friction-lowering component. Thus, the surface-modifying agent was confirmed not to have an adequate dispersion-enhancing effect when used in combination with carbon black.

Further, Comparative Examples 1 and 5, which did not contain colloidal silica as a magnetic layer component, presented frictional characteristics that were so low that the coefficient of friction could not be measured. Thus, a coefficient of friction-lowering component was determined to be essential for maintaining running durability.

These results showed that the present invention yielded a magnetic recording medium having both good surface smoothness and frictional characteristics.

As shown in Table 3, the use of a BaFe hydrogen reduction product as the ferromagnetic powder made it possible to lower the coercive force of the magnetic tape. As shown in Table 2, this resulted from lowering the coercive force of the magnetic powder by hydrogen reduction processing. The lower the coercive force, the smaller the external magnetic field that is required for recording, which is advantageous for recording. As set forth above, since the hydrogen reduction product had a hexagonal ferrite structure, it afforded high thermal stability as a result of that structure.

The magnetic recording medium of the present invention is suitable as a high-capacity data backup tape of which good running durability and high reliability over extended periods of use are demanded.

Although the present invention has been described in considerable detail with regard to certain versions thereof, other versions are possible, and alterations, pet mutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic recording medium comprising a magnetic layer containing a ferromagnetic powder and a binder on a nonmagnetic support, wherein
the ferromagnetic powder has a hexagonal ferrite structure,
the magnetic layer comprises:
a coefficient of friction-lowering component in the form of nonmagnetic inorganic particles, and
a compound in which a substituent selected from the group consisting of a hydroxyl group and a carboxyl group is directly substituted on an aromatic ring.

2. The magnetic recording medium according to claim 1, wherein the ferromagnetic powder is a hydrogen reduction product of a ferromagnetic hexagonal ferrite powder.

3. The magnetic recording medium according to claim 1, wherein the magnetic layer comprises no carbon black.

4. The magnetic recording medium according to claim 2, wherein the magnetic layer comprises no carbon black.

5. The magnetic recording medium according to claim 1, wherein the nonmagnetic inorganic particles are inorganic oxide colloid particles.

6. The magnetic recording medium according to claim 2, wherein the nonmagnetic inorganic particles are inorganic oxide colloid particles.

7. The magnetic recording medium according to claim 3, wherein the nonmagnetic inorganic particles are inorganic oxide colloid particles.

8. The magnetic recording medium according to claim 1, wherein the nonmagnetic inorganic particles are silica colloid particles.

9. The magnetic recording medium according to claim 2, wherein the nonmagnetic inorganic particles are silica colloid particles.

10. The magnetic recording medium according to claim 3, wherein the nonmagnetic inorganic particles are silica colloid particles.

11. The magnetic recording medium according to claim 1, wherein a number of aromatic ring contained in the compound is one.

12. The magnetic recording medium according to claim 2, wherein a number of aromatic ring contained in the compound is one.

13. The magnetic recording medium according to claim 3, wherein a number of aromatic ring contained in the compound is one.

14. The magnetic recording medium according to claim 1, wherein the aromatic ring is a naphthalene ring or a biphenyl ring.

15. The magnetic recording medium according to claim 1, wherein a number of the substituent contained in the aromatic ring is one or two.

16. The magnetic recording medium according to claim 1, wherein the compound is dihydroxynaphthalene or biphenylcarboxylic acid.

17. The magnetic recording medium according to claim 2, wherein the compound is dihydroxynaphthalene or biphenylcarboxylic acid.

18. The magnetic recording medium according to claim 3, wherein the compound is dihydroxynaphthalene or biphenylcarboxylic acid.

19. The magnetic recording medium according to claim 1, wherein the ferromagnetic powder has a ferrite composition denoted by general formula: AFe₁₂O₁₉, wherein A denotes at least one element selected from the group consisting of Ba, Sr, Pb, and Ca, and has a coercive force of equal to or lower than 230 kA/m.

20. The magnetic recording medium according to claim 1, wherein the magnetic layer comprises a granular substance that is different from the nonmagnetic inorganic particles.
